(19) United States
(12) Patent Application Publication
(10) Pub. No.: US 2022/0379907 A1
(43) Pub. Date: Dec. 1, 2022

(54) FACILITY INFORMATION PROVISION APPARATUS, FACILITY INFORMATION PROVISION METHOD, AND COMPUTER-READABLE RECORDING MEDIUM

(71) Applicant: HONDA MOTOR CO.,LTD., Tokyo (JP)

(72) Inventor: Shuichi KAZUNO, Saitama (JP)

(21) Appl. No.: 17/744,757

(22) Filed: May 16, 2022

(30) Foreign Application Priority Data
May 26, 2021 (JP) 2021-088161

(51) Int. Cl. B60W 50/14; B60W 20/20

(52) U.S. Cl. CPC B60W 50/14; B60W 20/20; B60W 2050/146

(57) ABSTRACT

A facility information provision apparatus may include a vehicle information acquisition unit configured to acquire vehicle information relating to a vehicle that is capable of feeding power, a facility information acquisition unit configured to acquire facility information indicating whether each of a plurality of facilities requires power, a facility specification unit configured to specify at least two target facilities that require the power based on the facility information, and an output unit configured to output information relating to the at least two target facilities specified by the facility specification unit, to a display unit included in the vehicle that is capable of feeding the power and that is shown in the vehicle information.

The contents of the following Japanese patent application(s) are incorporated herein by reference:

NO. 2021-088161 filed in JP on May 26, 2021

### BACKGROUND

### 1. Technical Field

The present invention relates to a facility information provision apparatus, a facility information provision method, and a program.

### 2. Related Art

Patent document 1 discloses that “the management server 13 determines, on the basis of the acquired refuge information on each refuge 11 and vehicle information on each power supply vehicle 12, a refuge 11 to be a power supply destination of each power supply vehicle 12”.

### CITATION LIST

### Patent Document

[Patent Document 1]
Japanese Patent Application Publication No. 2017-112806

### BRIEF DESCRIPTION OF THE DRAWINGS

FIG. 1 is a diagram showing an example of an overall configuration of a facility information provision system.

FIG. 2 is a diagram showing an example of a functional block of a facility information provision system.

FIG. 3 is a diagram schematically showing a system configuration of a control system included in a vehicle.

FIG. 4 is a diagram showing an example of a functional block of a management server.

FIG. 5 is a diagram showing an example of a screen showing a map in which an evacuation facility with a high priority is highlighted.

FIG. 6 is a diagram showing a flowchart showing an example of a procedure in which the management server specifies, among a plurality of evacuation facilities, an evacuation facility to be highlighted on a display unit of a vehicle.

FIG. 7 is a diagram showing a flowchart showing an example of a procedure in which the management server sets a priority of each of the plurality of evacuation facilities.

FIG. 8 is a diagram showing an example of a hardware configuration.

### DESCRIPTION OF EXEMPLARY EMBODIMENTS

Hereinafter, the invention will be described through embodiments of the invention, but the following embodiments do not limit the invention according to claims. Further, not all the combinations of features described in the embodiments are essential for means to solve the problem in the invention.

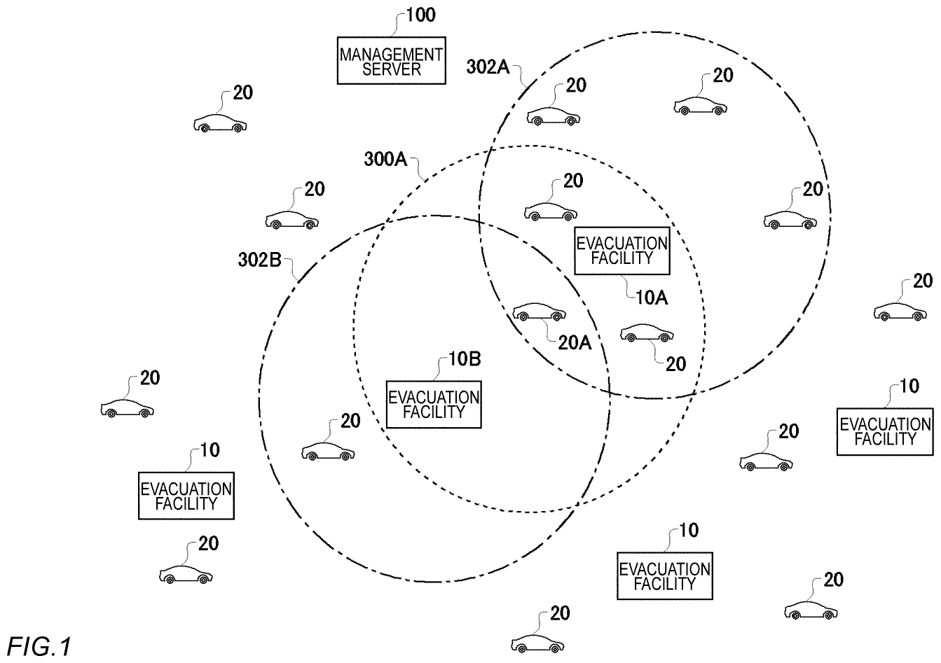

FIG. 1 shows an example of an overall configuration of a facility information provision system according to the present embodiment. The facility information provision system includes a management server 100, a plurality of evacuation facilities 10, and a plurality of vehicles 20. A vehicle 20 may be a hybrid vehicle, an electric vehicle, or a hydrogen vehicle that is capable of feeding power and that has a function of feeding the power to an outside. The evacuation facility 10 is a refuge provided in each region in the event of a disaster such as an earthquake. Connection of a power plug of an electrical device, which is provided in the evacuation facility 10, to a power outlet which is included in the vehicle 20 may cause the power to be supplied from the vehicle 20 to the electrical device.

The management server 100 collects information relating to an amount of power that is required by the evacuation facility 10 and information relating to an amount of power that is able to be supplied by the vehicle 20, and provides the vehicle 20 with information relating to at least two evacuation facilities 10 to which the vehicle 20 should go.

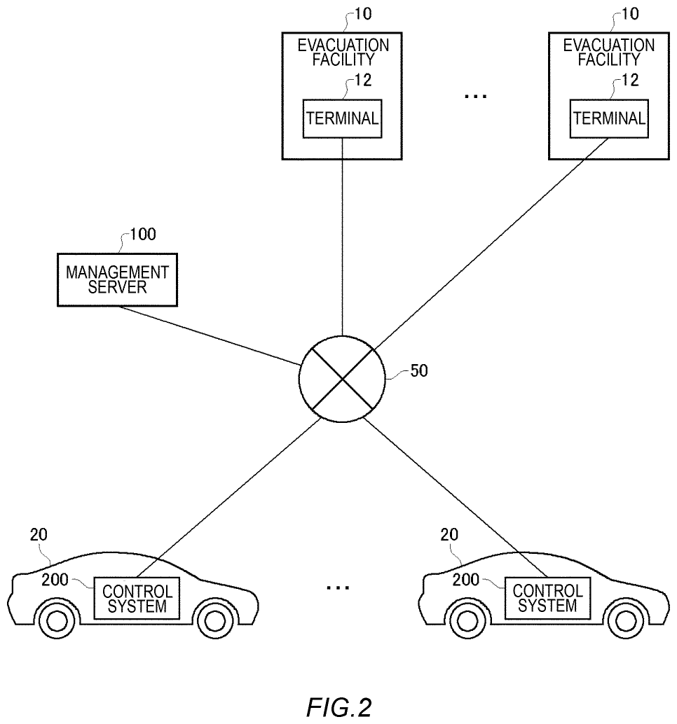

FIG. 2 shows an example of a functional block of a facility information provision system. The evacuation facility 10 includes a terminal 12 that manages whether the power is insufficient in the evacuation facility 10. The terminal 12 may determine whether the power is insufficient based on whether the evacuation facility 10 is in a power outage. The terminal 12 may determine whether the power is insufficient by receiving, from a user, an input of a message indicating that the power is insufficient. The terminal 12 may determine that the power is insufficient when the power outage is sensed by a device which is provided in the evacuation facility 10 to sense the power outage. For example, the terminal 12 may determine that the power is insufficient when an operation of an uninterruptible power supply device, which is provided in the evacuation facility 10, is sensed. When the evacuation facility 10 includes power storage equipment, the terminal 12 may determine whether the power is insufficient based on an amount of stored power of the power storage equipment. The terminal 12 may determine that the power is insufficient when the amount of stored power of the power storage equipment is smaller than or equal to a predetermined amount of stored power.

The terminal 12 may specify the amount of power that is required by the evacuation facility 10. The terminal 12 may specify the amount of power that is required by the evacuation facility 10 by receiving an input of a message indicating the amount of power that is required by the evacuation facility 10. When the evacuation facility 10 includes the power storage equipment, the terminal 12 may specify the amount of power that is required by the evacuation facility 10, based on the amount of stored power of the power storage equipment and on a predetermined amount of power that is necessary for the evacuation facility 10.

The vehicle 20 includes a control system 200 that controls the vehicle 20. The management server 100 communicates with the terminal 12 and the control system 200 via a network 50 such as the Internet. The management server 100 manages the amount of power that is required by each evacuation facility 10 and an amount of power that is able to be fed by each vehicle 20. The management server 100 specifies at least two evacuation facilities 10 to be presented to each vehicle 20, and provides each vehicle 20 with information relating to the at least two evacuation facilities 10.

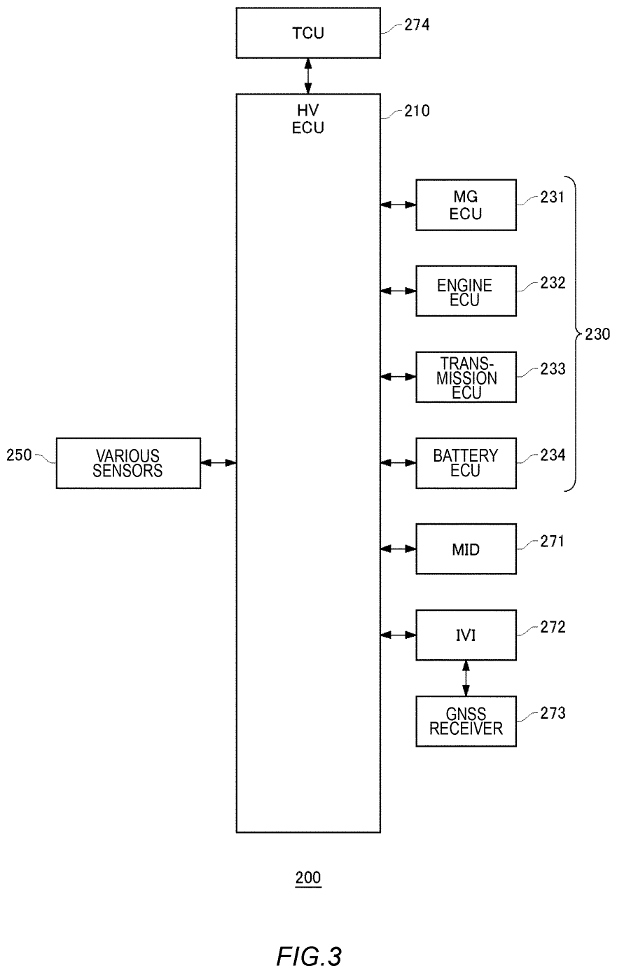

FIG. 3 schematically shows a system configuration of the control system 200 included in the vehicle 20. The control system 200 includes an HVECU 210, various ECUs 230, various sensors 250, an MID 271, an IVI 272, a GNSS receiver 273, and a TCU274.

The HVECU 210 is a hybrid ECU (Electronic Control Unit) that controls the vehicle 20. The HVECU 210 and the various ECUs 230 may be configured to include a so-called microcomputer including a CPU, a ROM, a RAM, an input and output interface, and the like. The HVECU 210 performs signal processing according to a program stored in advance in the ROM while using a temporary storage function of the RAM.

The HVECU 210 is connected to the MID 271, the IVI 272, the TCU274, and each ECU 230 via an in-vehicle communication circuit. The HVECU 210 communicates with the MID 271, the IVI 272, the TCU274, and the various ECUs 230 via the in-vehicle communication circuit. The HVECU 210 collectively controls the MID 271, the IVI 272, the TCU274, and each ECU 230 via the in-vehicle communication circuit. The in-vehicle communication circuit may be configured to include, for example, a CAN (Controller Area Network), an Ethernet network, or the like.

The MID 271 is a multi-information display. The IVI 272 is an in-vehicle infotainment (IVI) information device. The MID 271 and the IVI 272 are connected to the HVECU 210 via an in-vehicle communication line. The MID 271 and the IVI 272 can function as a display control unit and a display unit. The IVI 272 has a wireless LAN communication function. The GNSS receiver 273 specifies a location of the vehicle 20 based on a signal received from a GNSS (Global Navigation Satellite System) satellite.

The IVI 272 acquires location information of the vehicle 20 from the GNSS receiver 273. The IVI 272 outputs, to the HVECU 210, the location information acquired from the GNSS receiver 273.

The TCU 274 is a telematics control unit (Telematics Control Unit). The TCU 274 is mainly responsible for a mobile communication. The TCU 274 transmits and receives data to and from an external device based on the control of the HVECU 210.

The ECUs 230 respectively includes a MGECU 231, an engine ECU 232, a transmission ECU 233, and a battery ECU 234. The MGECU 231 controls a drive motor generator that is mounted on the vehicle 20. The engine ECU 232 controls an engine that is mounted on the vehicle 20. The transmission ECU 233 controls a transmission that is mounted on the vehicle 20. The battery ECU 234 controls a battery that is mounted on the vehicle 20 and that is a high voltage battery.

The HVECU 210 executes a hybrid drive control in relation with the motor generator via the MGECU 231, and the engine via the engine ECU 232. The HVECU 210 executes a shift control of the transmission via the transmission ECU 233. The HVECU 210 executes a charge and discharge control of the battery via the battery ECU 234. The various sensors 250 detect various states of the vehicle 20 which are necessary for controlling the vehicle 20. The various sensors 250 detect various states such as a vehicle speed, an accelerator opening degree, and an amount of charge of the battery.

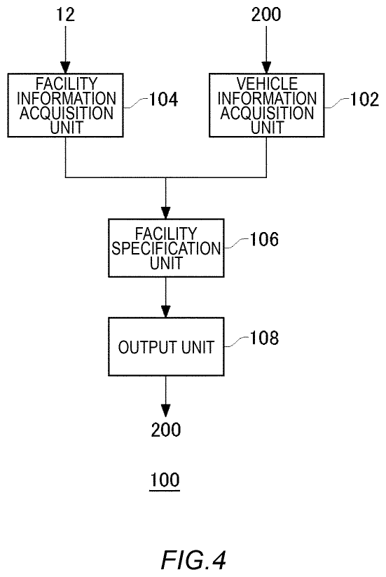

FIG. 4 shows an example of a functional block of a management server 100. The management server 100 includes a vehicle information acquisition unit 102, a facility information acquisition unit 104, a facility specification unit 106, and an output unit 108. The management server 100 may include a microprocessor such as a CPU or an MPU, a control unit such as a microcontroller such as an MCU, and a storage unit such as a memory. The memory may be a computer-readable recording medium, and may include at least one of an SRAM, a DRAM, an EPROM, an EEPROM, and a flash memory such as a USB memory. The control unit may function as the vehicle information acquisition unit 102, the facility information acquisition unit 104, the facility specification unit 106, and the output unit 108.

The vehicle information acquisition unit 102 is configured to acquire vehicle information relating to the vehicle 20 that is capable of feeding the power. The vehicle information acquisition unit 102 may acquire the vehicle information from each of the plurality of vehicles 20 via the network 50. The vehicle information indicates the amount of power [Wh: watt hour]that is able to be fed by the vehicle 20 and a current location (a latitude and a longitude) of the vehicle 20. The amount of power that is able to be fed by the vehicle 20 may be determined based on the amount of charge of the battery that is mounted on the vehicle 20.

The facility information acquisition unit 104 is configured to acquire facility information indicating whether each of the plurality of evacuation facilities 10 requires the power. The facility information acquisition unit 104 may acquire the facility information from each of the plurality of evacuation facilities 10 via the network 50. The facility information indicates the amount of power [Wh: watt hour]that is required by the evacuation facility 10 and a location (a latitude and a longitude) of the evacuation facility 10. When the amount of power shown in the facility information is greater than zero, the facility information indicates that the evacuation facility 10 requires the power.

The facility specification unit 106 is configured to specify, as target facilities to be presented to the vehicle 20, the at least two evacuation facilities 10 that require the power based on the facility information. The facility specification unit 106 may specify, as the target facilities to be presented to the vehicle 20, the at least two evacuation facilities 10 that require the power based on posture information and the vehicle information.

The output unit 108 is configured to output information relating to the at least two target facilities specified by the facility specification unit 106, to the display unit such as the MID 271 and the IVI 272 included in the vehicle 20 that is capable of feeding the power and that is shown in the vehicle information, via the communication interface. The output unit 108 may output, to the display unit of the vehicle 20, the information relating to the at least two target facilities such that the information relating to the at least two target facilities is highlighted more than information relating to the evacuation facility 10 other than the at least two target facilities, among the plurality of evacuation facilities 10. The output unit 108 may output, to the display unit of the vehicle 20, the information relating to the at least two target facilities such that the information relating to the at least two target facilities is highlighted, on a map that is displayed on the display unit of the vehicle 20, more than the information relating to the evacuation facility 10 other than the at least two target facilities, among the plurality of evacuation facilities 10.

As shown in FIG. 1, the facility specification unit 106 specifies an evacuation facility 10A and an evacuation facility 10B that are included in a predetermined range 300A from a vehicle 20A among the plurality of vehicles 20 that are capable of feeding the power. The facility specification unit 106 respectively specifies the number of target vehicles that are included in a predetermined range 302A from the evacuation facility 10A and that include the vehicle 20A, and the number of target vehicles that are included in a predetermined range 302B from the evacuation facility 10B and that include the vehicle 20A. In the example shown in FIG. 1, the facility specification unit 106 specifies six target vehicles that are included in the predetermined range 302A from the evacuation facility 10A. The facility specification unit 106 specifies two target vehicles that are included in the predetermined range 302B from the evacuation facility 10B. The facility specification unit 106 specifies, among the plurality of evacuation facilities 10, the at least two target facilities to be notified to the vehicle 20A, based on at least one of the number of the target vehicles including the vehicle 20A and a total amount of power that is able to be supplied by the target vehicles. The predetermined range 300A, the predetermined range 302A, and the predetermined range 302B may be, for example, ranges of a radius of 0.5 km, a radius of 1.0 km, or a radius of 5.0 km. Areas of the predetermined range 302A and the predetermined range 302B may be the same as an area of the predetermined range 300A, or may be larger than that of the predetermined range 300A. The predetermined range 302A and the predetermined range 302B are ranges including at least the vehicle 20A. The predetermined range 300A, the predetermined range 302A, and the predetermined range 302B may be ranges that the vehicle 20 is capable of reaching because a residual amount of stored power of the battery of the vehicle 20 is higher than or equal to a predetermined threshold value.

The facility specification unit 106 may specify, as a target facility to be notified to the vehicle 20A, the evacuation facility 10 for which the number of the target vehicles is smaller than a predetermined number, among the plurality of evacuation facilities 10. For example, the facility specification unit 106 may specify, as the target facility to be notified to the vehicle 20A, the evacuation facility 10 for which the number of the target vehicles is smaller than three or five, among the plurality of evacuation facilities 10. The predetermined number of the target vehicles may be predetermined for each evacuation facility 10. The predetermined number of the target vehicles may be determined according to a capacity of each evacuation facility 10.

The facility specification unit 106 may specify, as the target facility to be notified to the vehicle 20A, the facility for which the total amount of power that is able to be supplied by the target vehicles is smaller than the amount of power that is required by the evacuation facility 10, among the plurality of evacuation facilities 10.

The facility specification unit 106 may specify, as a target facility with a first priority to be notified to the vehicle 20A, the evacuation facility 10 for which the total amount of power that is able to be supplied by the target vehicles is smaller than the amount of power that is required by the evacuation facility 10, and the total amount of power that is able to be supplied by the target vehicles is smaller than a predetermined minimum amount of power necessary for the evacuation facility 10, among the plurality of evacuation facilities 10. The minimum amount of power may be predetermined for each evacuation facility 10. The minimum amount of power may be determined according to the capacity of each evacuation facility 10. The minimum amount of power may be, for example, 500 kWh, 400 kWh, 300 kWh, 200 kWh, or 100 kWh per day per capacity of the evacuation facility 10, which is 200 people.

The facility specification unit 106 may specify, as a target facility, with a second priority which is lower than the first priority, to be notified to the vehicle 20A, the evacuation facility 10 for which the total amount of power that is able to be supplied by the target vehicles is smaller than the amount of power that is required by the facility, and the total amount of power that is able to be supplied by the target vehicles is larger than or equal to the minimum amount of power, among the plurality of evacuation facilities 10.

The facility specification unit 106 may specify, as a target facility, with a third priority which is lower than the second priority, to be notified to the vehicle 20A, the evacuation facility 10 for which the number of the target vehicles is smaller than a predetermined number, and the total amount of power that is able to be supplied by the target vehicles is larger than or equal to the amount of power that is required by the evacuation facility 10, among the plurality of evacuation facilities 10.

The facility specification unit 106 may specify, as a target facility, with a fourth priority which is lower than the third priority, to be notified to the vehicle 20A, the evacuation facility 10 for which the number of the target vehicles is larger than or equal to a predetermined number, and the total amount of power that is able to be supplied by the target vehicles is larger than or equal to the amount of power that is required by the evacuation facility 10, among the plurality of evacuation facilities 10.

The output unit 108 may output, to the display unit of the vehicle 20, the information relating to each of the plurality of evacuation facilities 10 so as to be displayed in visually different manners according to the priority. The output unit 108 may output, to the display unit of the vehicle 20, the information relating to the evacuation facility 10 so as to be displayed, on the map that is displayed on the display unit of the vehicle 20, in color according to the priority of each of the plurality of evacuation facilities 10. For example, the output unit 108 may output, to the display unit of the vehicle 20, the information relating to each of the evacuation facilities 10 such that on the map, the evacuation facility 10 with the first priority is displayed in “red”, the evacuation facility 10 with the second priority is displayed in “orange”, the evacuation facility 10 with the third priority is displayed in “yellow”, and the evacuation facility 10 with the fourth priority is displayed in “black”. The information relating to the evacuation facility 10 may be a refuge mark indicating the evacuation facility shown on the map, or a name, an address, and the like of the refuge.

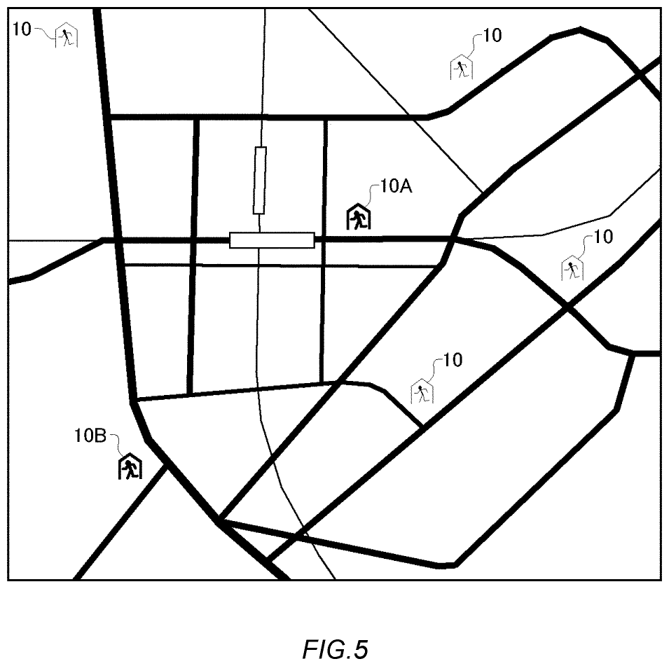

The output unit 108 may output, to a display unit of the vehicle 20A, the information relating to the at least two target facilities such that only the information relating to the at least two target facilities with the first priority is highlighted on the display unit, more than the information relating to the evacuation facility 10 other than the at least two target facilities with the first priority, among the plurality of evacuation facilities 10, when the facility specification unit 106 specifies the at least two target facilities with the first priority to be notified to the vehicle 20A among the plurality of evacuation facilities 10. For example, as shown in FIG. 5, the output unit 108 may output, to the display unit of the vehicle 20, the information relating to the evacuation facility 10A and the evacuation facility 10B such that the refuge mark of the evacuation facility 10A and the refuge mark of the evacuation facility 10B, which have the first priority, are highlighted on the map with a thicker line or in higher density than refuge marks of the other evacuation facilities 10.

The output unit 108 may output, to the display unit, the information relating to the at least two target facilities such that only the information relating to the at least two target facilities with the first priority is displayed. The output unit 108 may output, to the display unit of the vehicle 20A, the information relating to the at least two target facilities such that only the information relating to the at least two target facilities with the first priority is displayed on the map.

The facility specification unit 106 may specify the evacuation facility 10 that is new and is included in a first range from the vehicle 20A after power feeding to the evacuation facility 10 by the vehicle 20A is completed. Further, the facility specification unit 106 may specify, among the plurality of evacuation facilities 10, at least new two target facilities to be notified to the vehicle 20A, based on at least one of the number of new target vehicles that are included in a second range from the new evacuation facility 10 and a total amount of power that is able to be supplied by the new target vehicles. The output unit 108 may output, to the display unit of the vehicle 20A, the information relating to the at least two target facilities such that the information relating to the at least two new target facilities is highlighted, on the display unit of the vehicle 20A, more than the information relating to the evacuation facility 10 other than the at least two new target facilities, among the plurality of facilities.

As described above, the management server 100 causes the information relating to the at least two target facilities among the plurality of evacuation facilities 10, to be output to the display unit of the vehicle 20. A user of the vehicle 20 can select the evacuation facility 10 that is desired from among the at least two evacuation facilities 10 as targets requiring the power among the plurality of evacuation facilities 10, and the user can go to the evacuation facility 10 by the vehicle 20 that is capable of feeding the power. The at least two evacuation facilities 10 as the targets are facilities in which the power is insufficient and which are requiring the power due to an occurrence of a disaster. In addition, the management server 100 can preferentially notify the vehicle 20 of the evacuation facility 10 with a high priority from among the plurality of evacuation facilities 10 requiring the power. For example, the evacuation facility 10 with the high priority is a facility for which there are few vehicles 20 existing in a predetermined range from the evacuation facility 10. In addition, the evacuation facility 10 with the high priority is the evacuation facility 10 for which even the total amount of power of all the vehicles 20 existing in the predetermined range from the evacuation facility 10 is smaller than the amount of power necessary for the evacuation facility 10.

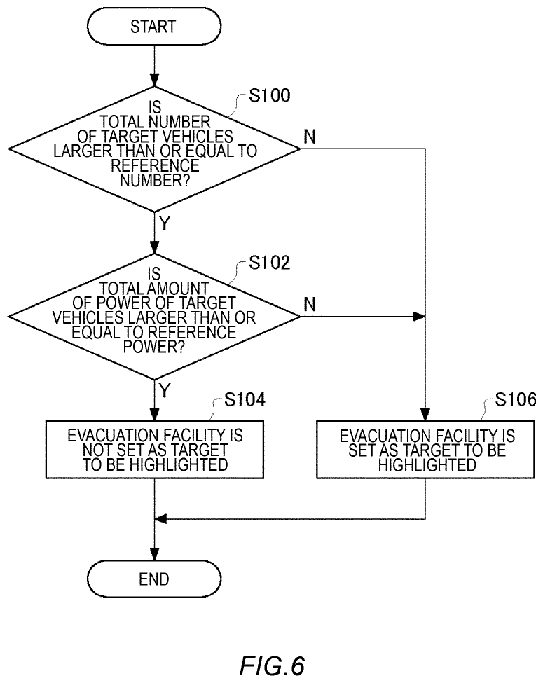

FIG. 6 is a flowchart showing an example of a procedure in which the management server 100 specifies, among a plurality of evacuation facilities 10, an evacuation facility 10 to be highlighted on a display unit of a vehicle 20A.

The facility specification unit 106 specifies the evacuation facility 10 existing in the first range 300 from the vehicle 20A based on the facility information and the vehicle information. Then, the facility specification unit 106 may execute the procedure shown in FIG. 6 for each of the specified evacuation facilities 10.

The facility specification unit 106 specifies the number of the target vehicles that exist in the second range 302 from the specified evacuation facility 10 and that include the vehicle 20A. Then, the facility specification unit 106 determines whether the number of the target vehicles is larger than or equal to a reference number (for example, five) (S100). If the number of the target vehicles is smaller than the reference number, the facility specification unit 106 determines that the specified evacuation facility 10 is a target to be highlighted (S106).

On the other hand, if the number of the target vehicles is larger than or equal to the reference number (for example, five), the facility specification unit 106 determines whether the total amount of power that is able to be fed by the target vehicles is larger than or equal to a reference amount of power which is the amount of power that is required by the evacuation facility 10 (S102). If the total amount of power that is able to be fed by the target vehicles is smaller than the reference amount of power which is the amount of power that is required by the evacuation facility 10, the specified evacuation facility 10 is determined to be the target to be highlighted (S106).

If the number of the target vehicles is larger than or equal to the reference number, and the total amount of power that is able to be fed by the target vehicles is larger than or equal to the reference amount of power which is the amount of power that is required by the evacuation facility 10, the facility specification unit 106 determines that the specified evacuation facility 10 is not the target to be highlighted (S104).

By the above procedure, if the number of the target vehicles is smaller than the reference number, or the total amount of power that is able to be fed by the target vehicles is smaller than the reference amount of power which is the amount of power that is required by the evacuation facility 10, the facility specification unit 106 determines that the evacuation facility 10 is the target facility with the high priority to which the vehicle 20A capable of feeding the power should go. The facility specification unit 106 determines whether each of the evacuation facilities 10 is the target to be highlighted. Then, the at least two evacuation facilities 10 with the high priority are highlighted on the display unit of the vehicle 20A.

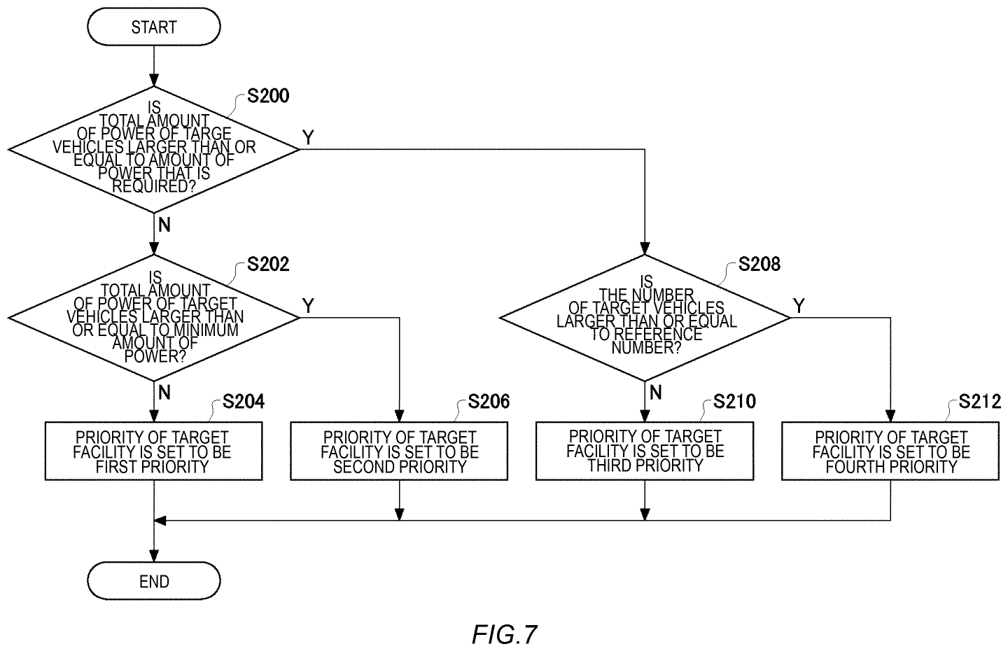

FIG. 7 is a flowchart showing an example of a procedure in which the management server 100 sets a priority of each of the plurality of evacuation facilities 10.

The facility specification unit 106 specifies the evacuation facility 10 existing in the first range 300 from the vehicle 20A based on the facility information and the vehicle information. Then, the facility specification unit 106 may execute the procedure shown in FIG. 7 for each of the specified evacuation facilities 10.

The facility specification unit 106 specifies the target vehicles that exist in the second range 302 from the specified evacuation facility 10 and that include the vehicle 20A. Then, the facility specification unit 106 determines whether the total amount of power of the target vehicles is larger than or equal to the amount of power that is required by the specified evacuation facility 10 (S200).

Then, if the total amount of power of the target vehicles is smaller than the amount of power that is required by the specified evacuation facility 10, the facility specification unit 106 determines whether the total amount of power of the target vehicles is larger than or equal to the minimum amount of power of the specified evacuation facility 10 (S202). Then, if the total amount of power of the target vehicles is smaller than the minimum amount of power of the specified evacuation facility 10, the facility specification unit 106 sets the priority of the specified evacuation facility 10 to be the first priority (S204).

On the other hand, if the total amount of power of the target vehicles is larger than or equal to the minimum amount of power of the specified evacuation facility 10, the facility specification unit 106 sets the priority of the specified evacuation facility 10 to be the second priority which is lower than the first priority (S206).

In addition, if the total amount of power of the target vehicles is larger than or equal to the amount of power that is required by the specified evacuation facility 10, the facility specification unit 106 determines whether the number of the target vehicles is larger than or equal to the reference number for the specified evacuation facility 10 (S208). If the number of the target vehicles is smaller than the reference number for the specified evacuation facility 10, the facility specification unit 106 sets the priority of the specified evacuation facility 10 to be the third priority which is lower than the second priority (S210). On the other hand, if the number of the target vehicles is larger than or equal to the reference number for the specified evacuation facility 10, the facility specification unit 106 sets the priority of the specified evacuation facility 10 to be the fourth priority which is lower than the third priority (S212).

By the above procedure, the facility specification unit 106 sets the priority of the evacuation facility 10 based on the total amount of power of the target vehicles and the number of the target vehicles. Then, the at least two evacuation facilities 10 are highlighted on the display unit of the vehicle 20A in a manner according to the priority.

As described above, with the present embodiment, according to the priority based on the total amount of power of the target vehicles and the number of the target vehicles, the at least two evacuation facilities 10 are highlighted on the display unit such as the MID 271 and the IVI 272 of the vehicle 20 as the evacuation facilities 10 to which the vehicle 20 should go to feed the power. The user of the vehicle 20 can select, according to a convenience of the user, the desired evacuation facility 10 from among the at least two evacuation facilities 10 that are displayed on the display unit, and go to feed the power. Even in a case where the evacuation facility 10 is not in the power outage, when the terminal 12 of the evacuation facility 10 notifies the management server 100 that the power is necessary, the evacuation facility 10 becomes a candidate for the evacuation facility 10 to which the vehicle 20 should go.

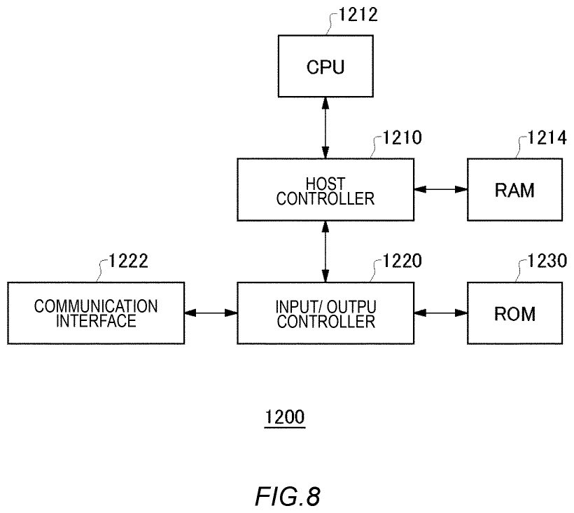

FIG. 8 shows an example of a computer 1200 in which a plurality of aspects of the present invention may be entirely or partially embodied. A program that is installed in the computer 1200 can cause the computer 1200 to function as operations associated with apparatuses according to the embodiments of the present invention or one or more “sections” of the apparatuses. Alternatively, the program can cause the computer 1200 to execute the operations thereof or the one or more “sections” thereof. The program can cause the computer 1200 to execute processes according to the embodiments of the present invention or steps of the processes. Such a program may be executed by a CPU 1212 so as to cause the computer 1200 to execute the specific operation associated with some or all of the blocks of flowcharts and block diagrams described in the present specification.

The computer 1200 according to the present embodiment includes the CPU 1212, and a RAM 1214, which are interconnected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to the programs stored in the ROM 1230 and the RAM 1214, thereby controlling each unit.

The communication interface 1222 communicates with other electronic devices via a network. A hard disk drive may store programs and data used by the CPU 1212 within the computer 1200. The ROM 1230 stores, in itself, a boot program or the like that is executed by the computer 1200 during activation, and/or a program that depends on hardware of the computer 1200. A program is provided via a computer-readable recording medium such as a CD-ROM, a USB memory, or an IC card, or a network. The program is installed in the RAM 1214, or the ROM 1230, which is also an example of the computer-readable recording medium, and executed by the CPU 1212. Information processing written in these programs is read by the computer 1200, resulting in cooperation between a program and the above-mentioned various types of hardware resources. An apparatus or method may be constituted by realizing the operation or processing of information in accordance with the usage of the computer 1200.

For example, when a communication is executed between the computer 1200 and an external device, the CPU 1212 may execute a communication program loaded in the RAM 1214, and instruct the communication interface 1222 to process the communication based on the processing written in the communication program. Under the control of the CPU 1212, the communication interface 1222 reads transmission data stored in a transmission buffer region provided in a recording medium such as the RAM 1214 or the USB memory, transmits the read transmission data to the network, or writes received data which is received from the network to a receiving buffer region or the like provided on the recording medium.

In addition, the CPU 1212 may cause all or a necessary portion of a file or a database to be read into the RAM 1214, the file or the database having been stored in an external recording medium such as the USB memory, etc., and execute various types of processing on the data on the RAM 1214. Then, the CPU 1212 may write back the processed data to the external recording medium.

Various types of information, such as various types of programs, data, tables, and databases, may be stored in the recording medium to undergo information processing. The CPU 1212 may execute various types of processing on the data read from the RAM 1214 to write back a result to the RAM 1214, the processing being described throughout the present disclosure, specified by instruction sequences of the programs, and including various types of operations, information processing, condition determinations, conditional branching, unconditional branching, information retrievals/replacements, or the like. In addition, the CPU 1212 may search for information in the file, the database, or the like in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-described program or software modules may be stored in a computer-readable storage medium on the computer 1200 or near the computer 1200. In addition, a recording medium such as a hard disk or a RAM provided in a server system connected to a dedicated communication network or the Internet can be used as the computer-readable storage medium, thereby providing the program to the computer 1200 via the network.

A computer-readable medium may include any tangible device that can store instructions for execution by a suitable device. As a result, the computer-readable medium having instructions stored in the tangible device comprises an article of manufacture including instructions which can be executed to create means for executing operations specified in the flowcharts or block diagrams. Examples of the computer-readable medium may include an electronic storage medium, a magnetic storage medium, an optical storage medium, an electromagnetic storage medium, a semiconductor storage medium, etc. Specific examples of the computer-readable medium may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a portable compact disc read-only memory (CD-ROM), a digital versatile disc (DVD), a Blu-ray (registered trademark) disc, a memory stick, an integrated circuit card, or the like.

Computer-readable instructions may include either source code or object code written in any combination of one or more programming languages. The source code or the object code includes conventional procedural programming languages. The conventional procedural programming languages may be assembler instructions, instruction-set-architecture (ISA) instructions, machine instructions, machine dependent instructions, microcode, firmware instructions, state-setting data, or an object oriented programming language such as Smalltalk (registered trademark), JAVA (registered trademark), C++, etc., and the “C” programming language or similar programming languages. The computer-readable instructions may be provided to a processor of a general-purpose computer, special purpose computer, or other programmable data processing apparatus, or to programmable circuitry, locally or via a local area network (LAN), wide area network (WAN) such as the Internet, etc. The processor or the programmable circuitry may execute the computer-readable instructions to create means for executing operations specified in the flowcharts or block diagrams. Examples of the processor include a computer processor, a processing unit, a microprocessor, a digital signal processor, a controller, a microcontroller, and the like.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10, 10A, 10B evacuation facility
12 terminal
20, 20A vehicle
50 network
100 management server
102 vehicle information acquisition unit
104 facility information acquisition unit
106 facility specification unit
108 output unit
200 control system
210 HVECU
230 ECU
231 MGECU
232 engine ECU
233 transmission ECU
234 battery ECU
250 various sensors
271 MID
272 IVI
273 GNSS receiver
274 TCU
1200 computer
1210 host controller
1212 CPU
1214 RAM
1220 input/output controller
1222 communication interface
1230 ROM

What is claimed is:

1. A facility information provision apparatus comprising:
a vehicle information acquisition unit configured to acquire vehicle information relating to a vehicle that is capable of feeding power;
a facility information acquisition unit configured to acquire facility information indicating whether each of a plurality of facilities requires power;
a facility specification unit configured to specify, based on the facility information, at least two target facilities that require the power; and
an output unit configured to output information relating to the at least two target facilities specified by the facility specification unit, to a display unit included in the vehicle that is capable of feeding the power and that is shown in the vehicle information.

2. The facility information provision apparatus according to claim 1, wherein
the output unit is configured to output, to the display unit, the information relating to the at least two target facilities such that the information relating to the at least two target facilities is highlighted more than information relating to a facility other than the at least two target facilities among the plurality of facilities.

3. The facility information provision apparatus according to claim 1, wherein
the vehicle information acquisition unit is configured to acquire the vehicle information indicating an amount of power that is able to be supplied by each of a plurality of vehicles capable of feeding the power, and a location of each of the plurality of vehicles,
the facility information acquisition unit is configured to acquire the facility information indicating an amount of power that is required by each of the plurality of facilities, and a location of each of the plurality of facilities, and
the facility specification unit is configured to specify, among the plurality of facilities, at least two target facilities to be notified to a first vehicle, based on at least one of a number of at least one target vehicle among the plurality of vehicles capable of feeding the power and a total amount of power that is able to be supplied by the target vehicles, the target vehicles being included in a predetermined second range from a facility included in a predetermined first range from the first vehicle, and the target vehicles including the first vehicle.

4. The facility information provision apparatus according to claim 2, wherein
the vehicle information acquisition unit is configured to acquire the vehicle information indicating an amount of power that is able to be supplied by each of a plurality of vehicles capable of feeding the power, and a location of each of the plurality of vehicles,
the facility information acquisition unit is configured to acquire the facility information indicating an amount of power that is required by each of the plurality of facilities, and a location of each of the plurality of facilities, and
the facility specification unit is configured to specify, among the plurality of facilities, at least two target facilities to be notified to a first vehicle, based on at least one of a number of at least one target vehicle among the plurality of vehicles capable of feeding the power and a total amount of power that is able to be supplied by the target vehicles, the target vehicles being included in a predetermined second range from a facility included in a predetermined first range from the first vehicle, and the target vehicles including the first vehicle.

5. The facility information provision apparatus according to claim 3, wherein
the facility specification unit is configured to specify, as a target facility to be notified to the first vehicle, a facility for which the number of the at least one target vehicle is smaller than a predetermined number, among the plurality of facilities.

6. The facility information provision apparatus according to claim 4, wherein
the facility specification unit is configured to specify, as a target facility to be notified to the first vehicle, a facility for which the number of the at least one target vehicle is smaller than a predetermined number, among the plurality of facilities.

7. The facility information provision apparatus according to claim 3, wherein
the facility specification unit is configured to specify, as a target facility to be notified to the first vehicle, a facility for which the total amount of power that is able to be supplied by the target vehicles is smaller than the amount of power that is required by the facility, among the plurality of facilities.

8. The facility information provision apparatus according to claim 5, wherein
the facility specification unit is configured to specify, as a target facility to be notified to the first vehicle, a facility for which the total amount of power that is able to be supplied by the target vehicles is smaller than the amount of power that is required by the facility, among the plurality of facilities.

9. The facility information provision apparatus according to claim 3, wherein
the facility specification unit is configured to specify, as a target facility with a first priority to be notified to the first vehicle, a facility for which the total amount of power that is able to be supplied by the target vehicles is smaller than the amount of power that is required by the facility and the total amount of power that is able to be supplied by the target vehicles is smaller than a predetermined minimum amount of power necessary for the facility, among the plurality of facilities, and
the facility specification unit is configured to specify, as a target facility with a second priority lower than the first priority to be notified to the first vehicle, a facility for which the total amount of power that is able to be supplied by the target vehicles is smaller than the amount of power that is required by the facility and the total amount of power that is able to be supplied by the target vehicles is larger than or equal to the minimum amount of power, among the plurality of facilities.

10. The facility information provision apparatus according to claim 4, wherein
the facility specification unit is configured to specify, as a target facility with a first priority to be notified to the first vehicle, a facility for which the total amount of power that is able to be supplied by the target vehicles is smaller than the amount of power that is required by the facility and the total amount of power that is able to be supplied by the target vehicles is smaller than a predetermined minimum amount of power necessary for the facility, among the plurality of facilities, and
the facility specification unit is configured to specify, as a target facility with a second priority lower than the first priority to be notified to the first vehicle, a facility for which the total amount of power that is able to be supplied by the target vehicles is smaller than the amount of power that is required by the facility and the total amount of power that is able to be supplied by the target vehicles is larger than or equal to the minimum amount of power, among the plurality of facilities.

11. The facility information provision apparatus according to claim 9, wherein
the facility specification unit is configured to specify, as a target facility with a third priority lower than the second priority to be notified to the first vehicle, a facility for which the number of the at least one target vehicle is smaller than a predetermined number and the total amount of power that is able to be supplied by the target vehicles is larger than or equal to the amount of power that is required by the facility, among the plurality of facilities, and
the facility specification unit is configured to specify, as a target facility with a fourth priority lower than the third priority to be notified to the first vehicle, a facility for which the number of the at least one target vehicle is larger than or equal to the predetermined number and the total amount of power that is able to be supplied by the target vehicles is larger than or equal to the amount of power that is required by the facility, among the plurality of facilities.

12. The facility information provision apparatus according to claim 10, wherein
the facility specification unit is configured to specify, as a target facility with a third priority lower than the second priority to be notified to the first vehicle, a facility for which the number of the at least one target vehicle is smaller than a predetermined number and the total amount of power that is able to be supplied by the target vehicles is larger than or equal to the amount of power that is required by the facility, among the plurality of facilities, and
the facility specification unit is configured to specify, as a target facility with a fourth priority lower than the third priority to be notified to the first vehicle, a facility for which the number of the at least one target vehicle is larger than or equal to the predetermined number and the total amount of power that is able to be supplied by the target vehicles is larger than or equal to the amount of power that is required by the facility, among the plurality of facilities.

13. The facility information provision apparatus according to claim 9, wherein
the output unit is configured to output, to a display unit of the first vehicle, the information relating to the at least two target facilities such that only the information relating to the at least two target facilities with the first priority is highlighted on the display unit, more than information relating to a facility other than the at least two target facilities with the first priority, among the plurality of facilities, when the facility specification unit specifies the at least two target facilities with the first priority to be notified to the first vehicle among the plurality of facilities.

14. The facility information provision apparatus according to claim 10, wherein
the output unit is configured to output, to a display unit of the first vehicle, the information relating to the at least two target facilities such that only the information relating to the at least two target facilities with the first priority is highlighted on the display unit, more than information relating to a facility other than the at least two target facilities with the first priority, among the plurality of facilities, when the facility specification unit specifies the at least two target facilities with the first priority to be notified to the first vehicle among the plurality of facilities.

15. The facility information provision apparatus according to claim 11, wherein
the output unit is configured to output, to a display unit of the first vehicle, the information relating to the at least two target facilities such that only the information relating to the at least two target facilities with the first priority is highlighted on the display unit, more than information relating to a facility other than the at least two target facilities with the first priority, among the plurality of facilities, when the facility specification unit specifies the at least two target facilities with the first priority to be notified to the first vehicle among the plurality of facilities.

16. The facility information provision apparatus according to claim 12, wherein
the output unit is configured to output, to a display unit of the first vehicle, the information relating to the at least two target facilities such that only the information relating to the at least two target facilities with the first priority is highlighted on the display unit, more than information relating to a facility other than the at least two target facilities with the first priority, among the plurality of facilities, when the facility specification unit specifies the at least two target facilities with the first priority to be notified to the first vehicle among the plurality of facilities.

17. The facility information provision apparatus according to claim 3, wherein
the facility specification unit is configured to specify, after power feeding to the facility by the first vehicle is completed, at least two new target facilities to be notified to the first vehicle among the plurality of facilities, based on at least one of the number of the at least one target vehicle and the total amount of power that is able to be supplied by the target vehicles, the target vehicles being included in the second range from the facility included in the first range from the first vehicle, and
the output unit is configured to output, to a display unit of the first vehicle, the information relating to the at least two target facilities such that information relating to the at least two new target facilities is highlighted on the display unit more than information relating to a facility other than the at least two new target facilities, among the plurality of facilities.

18. The facility information provision apparatus according to claim 4, wherein
the facility specification unit is configured to specify, after power feeding to the facility by the first vehicle is completed, at least two new target facilities to be notified to the first vehicle among the plurality of facilities, based on at least one of the number of the at least one target vehicle and the total amount of power that is able to be supplied by the target vehicles, the target vehicles being included in the second range from the facility included in the first range from the first vehicle, and
the output unit is configured to output, to a display unit of the first vehicle, the information relating to the at least two target facilities such that information relating to the at least two new target facilities is highlighted on the display unit more than information relating to a facility other than the at least two new target facilities, among the plurality of facilities.

19. A facility information provision method comprising:
acquiring vehicle information relating to a vehicle that is capable of feeding power;
acquiring facility information indicating whether each of a plurality of facilities requires power;
specifying, based on the facility information, at least two target facilities that require the power; and
outputting information relating to the at least two target facilities to a display unit included in the vehicle that is capable of feeding the power and that is shown in the vehicle information such that the information relating to the at least two target facilities specified is displayed on the display unit.

20. A computer-readable recording medium having recorded thereon a program for causing a computer to perform operations comprising:
acquiring vehicle information relating to a vehicle that is capable of feeding power;
acquiring facility information indicating whether each of a plurality of facilities requires power;
specifying, based on the facility information, at least two target facilities that require the power; and
outputting information relating to the at least two target facilities to a display unit included in the vehicle that is capable of feeding the power and that is shown in the vehicle information such that the information relating to the at least two target facilities specified is displayed on the display unit.
